(19) United States
(12) Patent Application Publication
(10) Pub. No.: US 2014/0103723 A1
(43) Pub. Date: Apr. 17, 2014

(54) MAXIMUM POWER POINT CONTROLLER TRANSISTOR DRIVING CIRCUITRY AND ASSOCIATED METHODS

(71) Applicant: VOLTERRA SEMICONDUCTOR CORPORATION, Fremont, CA (US)

(72) Inventors: Ilija Jergovic, Palo Alto, CA (US); Anthony J. Stratakos, Kentfield, CA (US); Xin Zhang, San Jose, CA (US); Vincent W. Ng, Milpitas, CA (US)

(73) Assignee: VOLTERRA SEMICONDUCTOR CORPORATION, Fremont, CA (US)

(21) Appl. No.: 13/653,392

(22) Filed: Oct. 16, 2012

(51) Int. Cl. H02J 1/10; G05F 3/08

(52) U.S. Cl. 307/43; 323/311

(57) ABSTRACT

An electric power system includes a string of N maximum power point tracking (MPPT) controllers having output ports electrically coupled in series, where N is an integer greater than one. At least one of the N MPPT controllers includes respective transistor driver circuitry powered from a power supply rail of an adjacent one of the N MPPT controllers of the string. Another MPPT controller includes an n-channel field effect freewheeling transistor electrically coupled across an output port and a resistive device electrically coupled between an input port and a gate of the freewheeling transistor, such that the freewheeling transistor operates in its conductive state when power is applied to the input port and a control subsystem of the controller is in an inactive state.

### BACKGROUND

Photovoltaic cells produce a voltage that varies with current, cell operating condition, cell physics, cell defects, and cell illumination. One mathematical model for a photovoltaic cell, as illustrated in FIG. 1, models output current as:

$$I = {I}_{L} - {I}_{0} \{ exp [ \frac{q ( V + {IR}_{S} )}{nkT} ] - 1 \} - \frac{V + {IR}_{S}}{{R}_{SH}} \qquad EQN . 1$$

### Where

I_{L}=photogenerated current

R_{S}=series resistance

R_{SH}=shunt resistance

I₀=reverse saturation current

n=diode ideality factor (1 for an ideal diode)

q=elementary charge

k=Boltzmann's constant

T=absolute temperature

I=output current at cell terminals

V=voltage at cell terminals

For silicon at 25° C., kT/q=0.0259 Volts.

Typical cell output voltages are low and depend on the band gap of the material used to manufacture the cell. Cell output voltages may be merely half a volt for silicon cells, far below the voltage needed to charge batteries or drive most other loads. Because of these low voltages, cells are typically connected together in series to form a module, or an array, having an output voltage much higher than that produced by a single cell.

Real-world photovoltaic cells often have one or more microscopic defects. These cell defects may cause mismatches of series resistance R_{S}, shunt resistance R_{SH}, and photogenerated current I_{L} from cell to cell in a module. Further, cell illumination may vary from cell to cell in a system of photovoltaic cells, and may vary even from cell to cell in a module, for reasons including shadows cast by trees, bird droppings shadowing portions of a cell or module, dust, dirt, and other effects. These mismatches in illumination may vary from day to day and with time of day—a shadow may shift across a module during a day, and rain may wash away dust or dirt shadowing a cell.

From EQN. 1, output voltage is greatest at zero output current, and output voltage V falls off nonlinearly with increasing output current I. FIG. 2 illustrates the effect of increasing current drawn from a photovoltaic device at constant illumination. As current I is increased under constant illumination, voltage V falls off slowly, but as current I is increased to an output current near the photocurrent I_{L}, output voltage V falls off sharply. Similarly, cell power, the product of current and voltage, increases as current I increases, until falling voltage V overcomes the effect of increasing current, whereupon further increases in current I drawn from the cell cause power P to decrease rapidly. For a given illumination, each cell, module, and array of cells and modules therefore has a maximum power point (MPP) representing the voltage and current combination at which output power from the device is maximized. The MPP of a cell, module, or array will change as temperature and illumination, and hence photo-generated current I_{L}, changes. The MPP of a cell, module, or array may also be affected by factors such as shadowing and/or aging of the cell, module, or array.

Maximum Power Point Tracking (MPPT) controllers for operating a photovoltaic device at or near its maximum power point have been proposed. These controllers typically determine an MPP voltage and current for a photovoltaic device connected to their input, and adjust their effective impedance to maintain the photovoltaic device at the MPP. While many MPPT controllers are designed for parallel output connection, some existing MPPT controllers are designed to have their outputs connected in a series string configuration.

FIG. 3 shows a prior art electric power system 300 including a string of N MPPT controllers 302, where N is an integer greater than one. In this document, specific instances of an item may be referred to by use of a numeral in parentheses (e.g., MPPT controller 302(1)) while numerals without parentheses refer to any such item (e.g., MPPT controllers 302). Each MPPT controller 302 includes an input port 308 with a high side input terminal 310 and a low side input terminal 312. Each input port 308 is electrically coupled to a respective photovoltaic device (not shown). Each MPPT controller 302 further includes an output port 314 including a high side output terminal 316 and a low side output terminal 318. Output ports 314 are electrically coupled in series with a load 306 and energy storage inductance 336 by an output circuit 332. One or more output capacitors 334 are typically electrically coupled in parallel with load 306.

Each MPPT controller 302 includes a control transistor 328 and a freewheeling transistor 330. In this document, a transistor's gate, drain, and source may be denoted as “G,” “D,” and “S,” respectively. Control transistor 328 is electrically coupled between high side input terminal 310 and high side output terminal 316, and freewheeling transistor 330 is electrically coupled between high side output terminal 316 and low side output terminal 318. Transistor 328 is referred to as the “control” transistor because the ratio of input voltage Vin across input port 308 to output voltage Vout across load 306 is a function of transistor 328's duty cycle.

Each MPPT controller 302 further includes a control subsystem 338, a regulator 342, high side transistor driver circuitry 344, low side transistor driver circuitry 346, and a “bootstrap” power supply 348. Low side transistor driver circuitry 346 drives a gate-to-source voltage of freewheeling transistor 330 between at least two different voltage levels to cause the transistor to switch between its conductive and non-conductive states, in response to a signal from control subsystem 338. High side transistor driver circuitry 344 drives a gate-to-source voltage of control transistor 328 between at least two different voltage levels to cause the transistor to switch between its conductive and non-conductive states, in response to a signal from control subsystem 338. Regulator 342 generates a “housekeeping” power supply rail Vcc from positive and reference power supply rails Vddh, Vss, respectively. Power supply rail Vcc is used to power control subsystem 338 and low side transistor driver circuitry 346. High side transistor driver circuitry 344 requires a higher electrical potential than positive power supply Vddh to provide a positive gate-to-source voltage for control transistor 328. Accordingly, bootstrap power supply 348 generates a bootstrap power supply rail Vbst from Vcc, where Vbst is at a higher electrical potential than Vddh.

Each MPPT controller 302 has at least two operating modes. In an MPPT operating mode, switching device 328, 330, energy storage inductance 336, and output capacitors 334 collectively form a buck converter controlled by control subsystem 338. Control subsystem 338 causes the buck converter to transfer power from a photovoltaic device electrically coupled to input port 308 to load 306, while maximizing power extracted from the photovoltaic device. In a bypass operating mode, control subsystem 338 causes control transistor 328 to operate in its non-conductive state and freewheeling transistor 330 to operate in its conductive state, to provide a low impedance bypass pass for output current Tout flowing through output port 314. The bypass operating mode is used, for example, when the photovoltaic device provides enough power to operate control subsystem 338, but not enough power to support full controller 302 operation.

Although MPPT controllers 302 have a number of advantages, such as high performance and relative simplicity, they have some drawbacks. For example, bootstrap power supply 348 does not enable control transistor 328 to operate at one hundred percent duty cycle, where duty cycle is the proportion of each switching cycle that transistor 328 operates in its conductive state. In particular, bootstrap power supply 348 generates power supply rail Vbst from a capacitor (not shown) with a bottom terminal referenced to a switching node Vx. A top terminal of the capacitor is repeatedly switched between Vcc and Vbst. Specifically, the top terminal is electrically coupled to Vcc when control switching device 330 is in its conductive state to charge the capacitor, and the top terminal is then electrically coupled to Vbst to power the rail. Accordingly, freewheeling transistor 330 must periodically operate in its conductive state to charge the bootstrap capacitor, thereby preventing continuous conduction of control switching device 328.

As another example, MPPT controllers 302 are unable to operate in their bypass modes at low input power. Specifically, input power from input port 308 must be sufficiently high to power control subsystem 338, regulator 342, and low side driver circuitry 346, to enable freewheeling transistor 330 to operate in its conductive state. If freewheeling transistor 330 does not operate in its conductive state, output circuit current Tout will flow through freewheeling transistor body diode 350, instead of through the transistor itself, during bypass operation. This bypass current path is typically undesirable because body diode 350 has a relatively large forward voltage drop of around 0.7 volts, resulting in large power loss at high Tout magnitude.

### SUMMARY

In an embodiment, an electric power system includes a string of N maximum power point tracking (MPPT) controllers having output ports electrically coupled in series, where N is an integer greater than one. At least one of the N MPPT controllers includes respective transistor driver circuitry powered from a power supply rail of an adjacent one of the N MPPT controllers of the string.

In an embodiment, an electric power system includes first and second photovoltaic devices, a first maximum power point tracking (MPPT) controller including an input port electrically coupled to the first photovoltaic device, and a second MPPT controller including an input port electrically coupled to the second photovoltaic device. Output ports of the first and second MPPT controllers are electrically coupled in series, and transistor driver circuitry of the second MPPT controller is powered from a power supply rail of the first MPPT controller.

In an embodiment, an electric power system includes first and second photovoltaic devices, a first maximum power point tracking (MPPT) controller, and a second MPPT controller. The first MPPT controller includes a first input port electrically coupled to the first photovoltaic device, a first output port including a first high side output terminal and a first low side output terminal, a first power supply rail referenced to the first low side output terminal, a first transistor referenced to the first high side output terminal, and first transistor driver circuitry adapted to drive a gate-to-source voltage of the first transistor between at least two different voltage levels. The second MPPT controller includes a second input port electrically coupled to the second photovoltaic device, a second output port including a second high side output terminal and a second low side output terminal, the second high side output terminal being electrically coupled to the first low side output terminal, a second transistor referenced to the second high side output terminal, and second transistor driver circuitry powered from the first power supply rail. The second transistor driver circuitry is adapted to drive a gate-to-source voltage of the second transistor between at least two different voltage levels.

In an embodiment, a maximum power point tracking (MPPT) controller includes: (a) an input port for electrically coupling to an electric power source, the input port having low side and high side input terminals; (b) an output port for electrically coupling to a load, the output port having low side and high side output terminals; (c) a control transistor electrically coupled between the high side input terminal and the high side output terminal; (d) an n-channel field effect freewheeling transistor having a gate, a drain, and a source, the drain electrically coupled to the high side output terminal and the source electrically coupled to the low side output terminal; (e) transistor driver circuitry adapted to drive a gate-to-source voltage of the freewheeling transistor between at least two different voltage levels; and (f) a resistive element electrically coupled between the high side input terminal and the gate of the freewheeling transistor. The low side input terminal is electrically coupled to the low side output terminal.

In an embodiment, a maximum power point tracking (MPPT) controller includes: (a) an input port for electrically coupling to an electric power source; (b) an output port for electrically coupling to a load; (c) an n-channel field effect freewheeling transistor electrically coupled across the output port; (d) a control subsystem adapted to control a gate-to-source voltage of the freewheeling transistor; and (e) a resistive device electrically coupled between the input port and the gate of the freewheeling transistor such that the freewheeling transistor operates in its conductive state when power is applied to the input port and the control subsystem is in an inactive state.

In an embodiment, a method for operating a maximum power point tracking (MPPT) controller including an input port electrically coupled to a photovoltaic device and an output port electrically coupled to a load includes the steps of: (a) operating the MPPT controller in an MPPT operating mode, where the MPPT controller maximizes power extracted from the photovoltaic device and transferred to the load; (b) switching the MPPT controller from the MPPT operating mode to a bypass operating mode when a voltage across the input port drops below an under-voltage threshold value, the MPPT controller causing a transistor electrically coupled across the output port to continuously operate in a conductive state while in the bypass operating mode; and (c) switching the MPPT controller from the bypass operating mode to the MPPT operating mode when the voltage across the input port rises above a starting threshold value.

### BRIEF DESCRIPTION OF THE DRAWINGS

FIG. 1 shows one model of a photovoltaic cell.

FIG. 2 shows a graph of voltage and power as a function of current for one photovoltaic cell.

FIG. 3 shows a prior art electric power system including a string of MPPT controllers.

FIG. 4 shows an electric power system including a string of MPPT controllers with low power bypass capability and driver circuitry powered from an adjacent controller, according to an embodiment.

FIG. 5 shows a portion of the string of FIG. 4 MPPT controllers.

FIG. 6 shows a variation of the electric power system of FIG. 4, according to an embodiment.

FIG. 7 shows an MPPT controller which is similar to the MPPT controllers of FIGS. 4 and 5, but includes charge pump circuitry and a bootstrap power supply to power high side transistor driver circuitry, according to an embodiment.

FIG. 8 shows an MPPT controller which is similar to the MPPT controllers of FIGS. 4 and 5, but includes charge pump circuitry to enable the controller to operate it freewheeling transistor in its conductive state when power is unavailable at its input port, according to an embodiment.

FIG. 9 shows a graph of output port voltage versus time for one particular embodiment of the FIG. 8 MPPT controller.

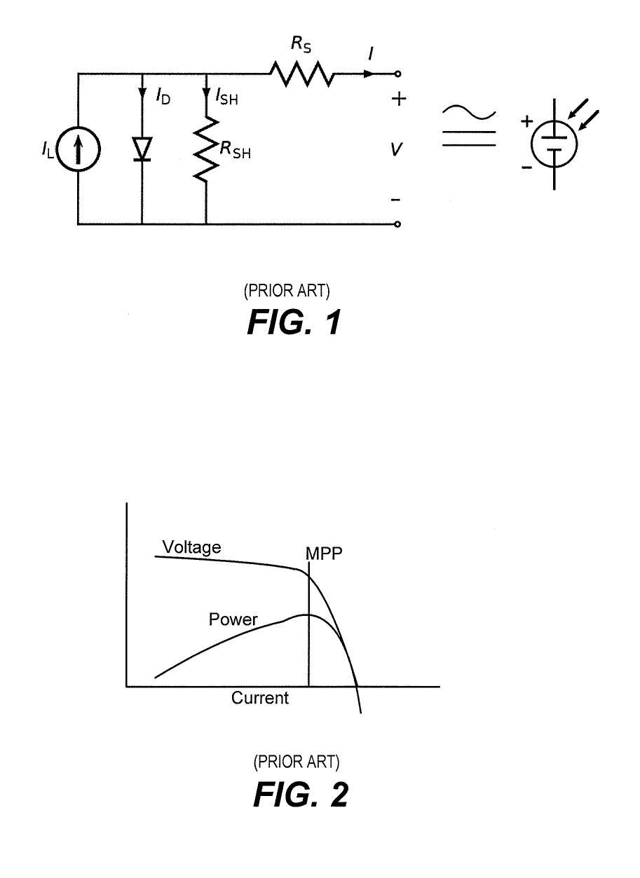

### DETAILED DESCRIPTION OF THE EMBODIMENTS

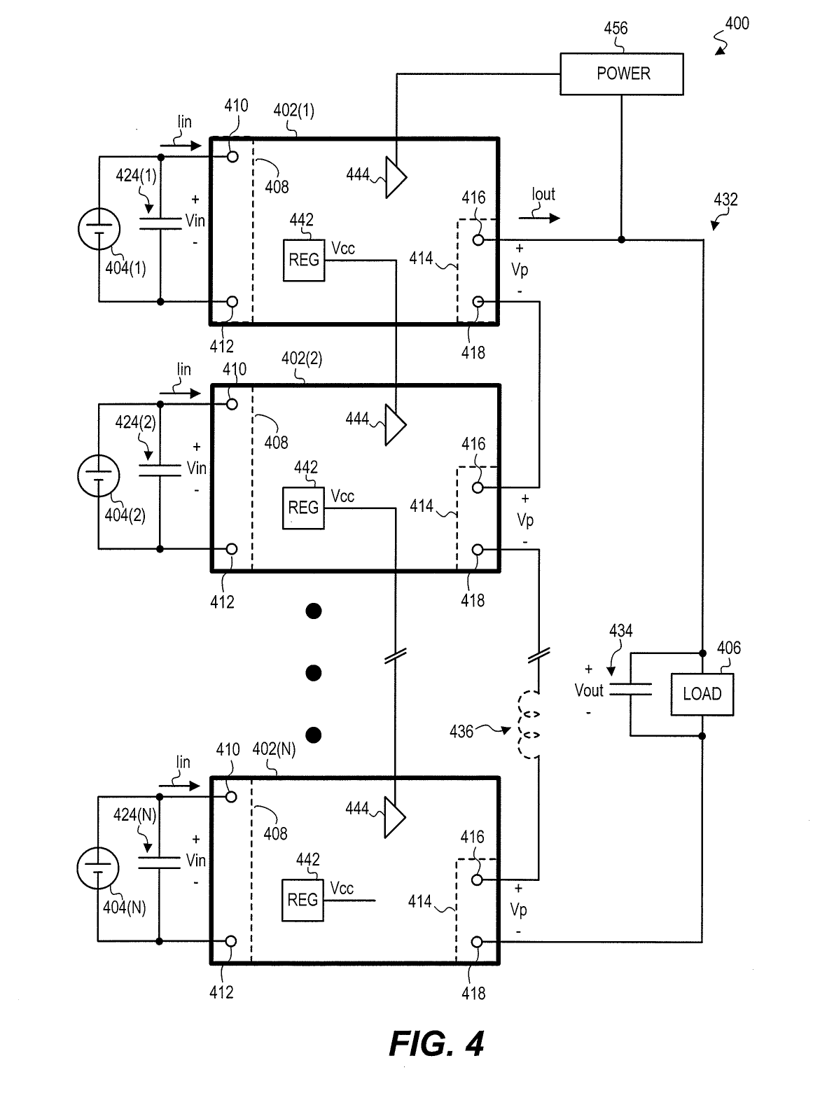

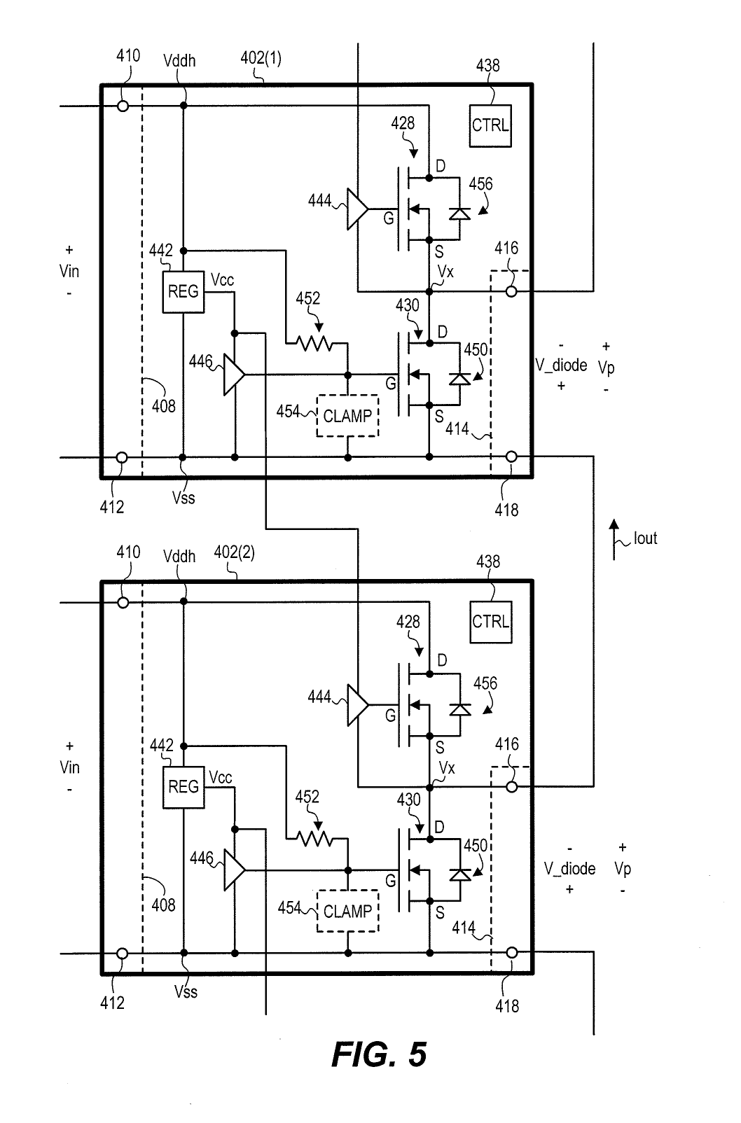

Applicants have developed MPPT controllers with transistor driver circuitry which may at least partially overcome one or more of the drawbacks discussed above with respect to prior MPPT controllers. For example, FIG. 4 shows an electric power system 400 including a string of N MPPT controllers 402, where N is an integer greater than one. As discussed below, MPPT controllers 402 do not require bootstrap capacitor charging, and controllers 402 also support bypass at low input power levels. FIG. 5 shows a portion of the string in greater detail; only certain blocks of controllers 402 are shown in FIG. 4 to promote illustrative clarity. FIGS. 4 and 5 are best viewed together in the following discussion.

Each MPPT controller 402 includes an input port 408 having a high side input terminal 410 and a low side input terminal 412 electrically coupled to a respective photovoltaic device 404. Terminal 410 forms part of a positive power node or rail (Vddh), and terminal 412 forms part of a reference power node or rail (Vss). Photovoltaic devices 404 are, for example, single junction photovoltaic cells, multi-junction photovoltaic cells, or a plurality of electrically interconnected photovoltaic cells. In some embodiments, photovoltaic cells 404 are part of a common module or array. However, MPPT controllers 402 are not limited to photovoltaic applications; some alternate embodiments of system 400 include other electric power sources, such as batteries or fuel cells, in place of photovoltaic devices 402. An input capacitor 424 is typically electrically coupled across each input port 408 to supply the ripple current component of controller input current Iin. In some embodiments where MPPT controllers 402 switch at a relatively high frequency, such as at 500 kilohertz or greater, capacitors 424 are ceramic capacitors to promote small size and high reliability.

Each MPPT controller 402 further includes an output port 414 having a high side output terminal 416 and a low side output terminal 418. Output ports 414 are electrically coupled in series to form a string of N MPPT controllers 402, where a high side output terminal 416 of one controller 402 is electrically coupled to a low side output terminal 418 of an adjacent controller in the string. For example, high side output terminal 416 of MPPT controller 402(2) is electrically coupled to low side output terminal 418 of controller 402(1). The output ports, in turn, are electrically coupled to a load 406 which is, for example, an inverter or battery charger. One or more output capacitors 434 are typically electrically coupled in parallel with load 406. In some embodiments, however, load 406 has significant capacitance which takes the place of or supplements discrete output capacitors 434. MPPT controllers 402 share common output capacitors 434 in the embodiment shown. However, in some alternate embodiments, one or more controller 402 instance has its own dedicated output capacitance. In some embodiments where MPPT controllers 402 switch at a relatively high frequency, such as at 500 kilohertz or greater, capacitors 434 are ceramic capacitors to promote small size and high reliability.

MPPT controllers 402 also share common energy storage inductance 436 which is “parasitic” interconnection inductance of an output circuit 432 electrically coupling output ports 414 together and to load 406. Although energy storage inductance 436 is symbolically shown as a single element, the inductance is distributed along the loop forming output circuit 432. Some alternate embodiments, though, include one or more discrete inductors in output circuit 432, such as in applications where relatively high inductance values are required. Additionally, in some other alternate embodiments, a discrete energy storage inductor (not shown) is electrically coupled to each controller output port 414, such that MPPT controllers 402 do not share energy storage inductance. In embodiments where each controller 402 has its own output capacitor, each controller 402 must also have its own energy storage inductor.

Each MPPT controller 402 further includes an N-channel field effect control transistor 428, an N-channel field effect freewheeling transistor 430, a control subsystem 438, a regulator 442, high side transistor driver circuitry 444, low side transistor driver circuitry 446, a resistive device 452, and an optional voltage limiting subsystem 454. Control transistor 428's drain and source are electrically coupled to high side input terminal 410 and high side output terminal 416, respectively. Thus, control transistor 428 is referenced to high side output terminal 416. Freewheeling transistor 430's drain and source are electrically coupled to high side output terminal 416 and low side output terminal 418, respectively. Thus, freewheeling transistor 430 is referenced to low side output terminal 418. High side output terminal 416 forms part of switching node Vx, joining control and freewheeling transistors 428, 430. Low side input terminal 412 is electrically coupled to low side output terminal 418.

Low side transistor driver circuitry 446 drives a gate-to-source voltage of freewheeling transistor 430 between at least two different voltage levels to cause the transistor to switch between its conductive and non-conductive states, in response to a signal from control subsystem 438. High side transistor driver circuitry 444 drives a gate-to-source voltage of control transistor 428 between at least two different levels to cause the transistor to switch between its conductive and non-conductive states, in response to a signal from control subsystem 438. High side transistor driver circuitry 444 and low side transistor driver circuitry 446 are referenced to high side and low side output terminals 416, 418, respectively. Regulator 442 generates a “housekeeping” power supply rail Vcc from positive and reference power supply rails Vddh, Vss, respectively. Power supply rail Vcc is used, for example, to power control subsystem 438 and low side transistor driver circuitry 446.

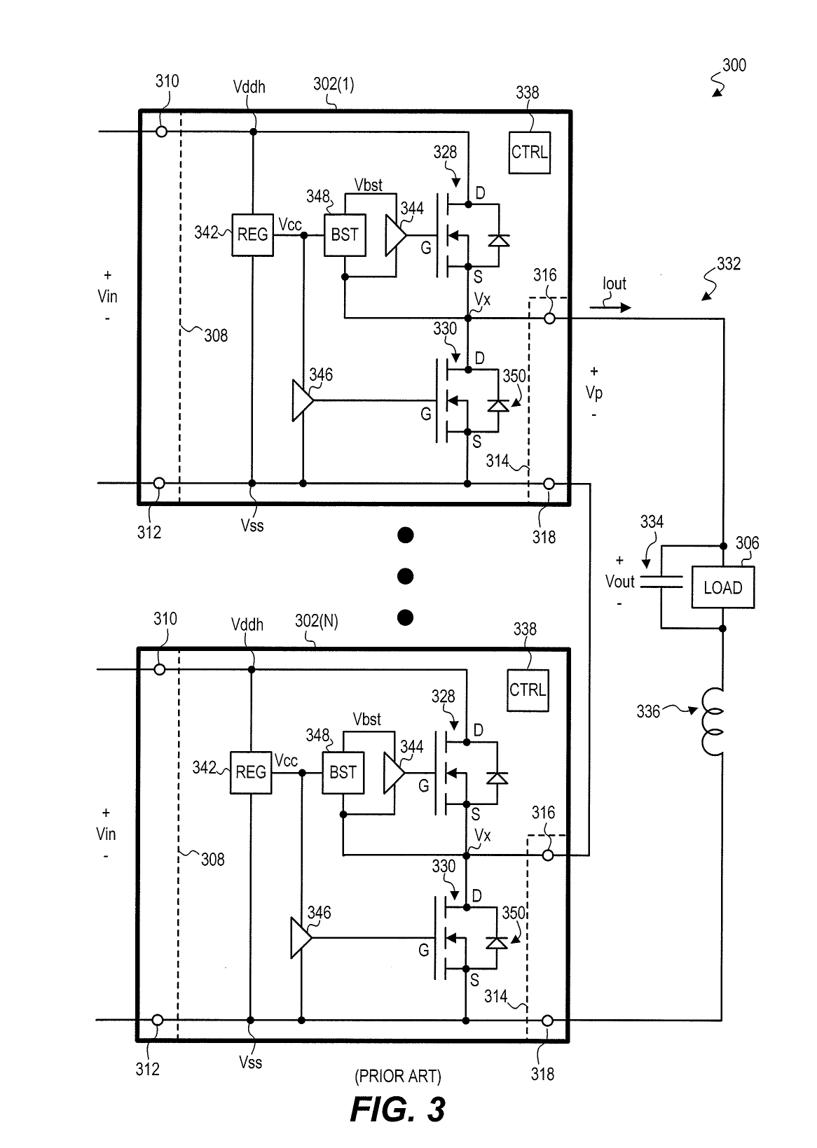

High side transistor driver circuitry 444 requires a higher electrical potential than that of positive power rail Vddh to provide a positive gate-to-source voltage for control transistor 428. However, in contrast to prior MPPT controller 302 of FIG. 3, MPPT controller 402 of FIG. 4 does not require a bootstrap power supply. Instead, high side driver circuitry 444 is powered from the Vcc power supply rail of an adjacent MPPT controller 402 of the string. For example, high side transistor driver circuitry 444 of MPPT controller 402(2) is powered from the Vcc power supply rail of adjacent MPPT controller 402(1) in the string. Thus, Vcc connections are “daisy-chained” along the string. Due to the series coupling of output ports 414, the Vcc rail of controller 402(1) is referenced to switching node Vx of controller 402(2), such that the Vcc rail of controller 402(1) provides a positive voltage with respect to switching node Vx of controller 402(2).

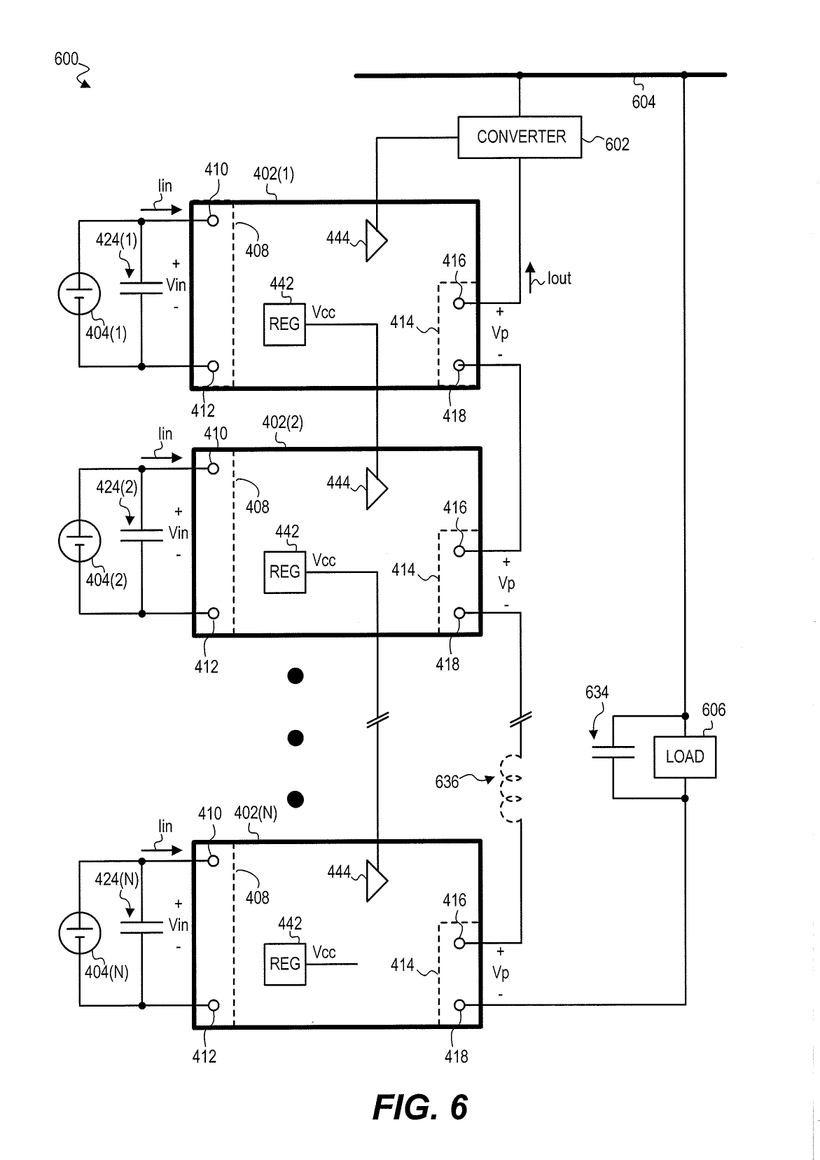

Driver circuitry 444 of top MPPT controller 402(1), however, is powered from a power source 456, instead of from another MPPT controller, since there are no other MTTP controllers above controller 402(1) in the string. Power source 456 is, for example, a power supply separate from controllers 402 and powered from output circuit 432. However, power source 456 could take other forms without departing from the scope hereof, such as a power source integrated in one of controllers 402, a power source powered by a circuit other than output circuit 432, or a string optimizer power, such as discussed below with respect to FIG. 6.

The fact that high side driver circuitry 444 is powered from an adjacent controller's Vcc power rail, instead of from a bootstrap power supply, eliminates the need for freewheeling transistor conduction to charge a bootstrap capacitor. Accordingly, some embodiments of controller 402 support one hundred percent duty cycle operation of control switching device 428. One hundred percent duty cycle operation is typically desirable when photovoltaic device 402 is operating near its MPP by default, and switching losses would likely more than offset additional power extracted by MPPT operation.

Each MPPT controller 402 has at least two operating modes. In an MPPT operating mode, each controller 402 maximizes power extracted from its respective photovoltaic device 404 and transfers the power to load 406. Specifically, control subsystem 438 causes control transistor 428 to repeatedly switch between its conductive and non-conductive states to charge and discharge inductance 436, thereby transferring power from input port 408 to output port 414, at a duty cycle which maximizes power extracted from photovoltaic device 404. Output capacitance 434 absorbs the ripple current component of output current Tout. Control subsystem 438 causes freewheeling transistor 430 to repeatedly switch between its conductive and non-conductive states to perform a freewheeling function, or in other words, to provide a path for output current Tout when control transistor 428 is in its non-conductive state. Thus, each MPPT controller 402 forms part of a buck converter in the MPPT operating mode, with shared inductance 436 and shared output capacitance 434 forming the remainder of the converter. Accordingly, system 400 includes N buck converters, where the buck converters share output inductance 436 and output capacitance 434.

MPPT controllers 402 maximize power extracted from their respective photovoltaic device, for example, by maximizing power into input port 408 or by maximizing power out of output port 414. In some embodiments, controllers 402 directly maximize input or output port power; in some other embodiments, controller 402 maximizes a signal associated with power, such as the average value of output port voltage Vp in applications where output current Tout is relatively constant.

Each MPPT controller 402 also has a low power bypass mode, where freewheeling transistor 430 operates in its conductive state to provide a low impedance bypass path for output current Tout flowing through output port 414. Controller 402 typically operates in its low power bypass mode when photovoltaic device 404 is supplying some power, but not enough power to operate control subsystem 438, regulator 442, and/or low side transistor driver circuitry 446 in their active states.

The low power bypass mode is enabled by resistive device 452 electrically coupled between the Vddh positive power rail and the gate of freewheeling transistor 430. Current produced by photovoltaic device 404 flows through resistive device 452 to drive the gate of freewheeling transistor 430 high relative to its source, thereby causing freewheeling transistor 430 to nominally be in its conductive state when power is applied to input port 408. When sufficient power is applied to input port 408 such that controller subsystem 438, regulator 442, and low side transistor driver circuitry 446 are in their active states, controller 438 controls freewheeling transistor 430 operation, such that the MPPT controller is no longer in its low power bypass mode. Thus, low side transistor driver circuitry 446 must be sufficiently strong to sink current flowing through resistive device 452, such that the driver circuitry can control transistor 430 when controller 402 is not in the low power bypass mode. Use of transistor 430, instead of its body diode 450, as a bypass device promotes efficiency because transistor 430 typically has a smaller voltage drop than body diode 450.

In certain embodiments, freewheeling transistor 430 is designed to have a lower threshold voltage (Vth) than a forward conduction voltage of its body diode 450, when current flows through transistor 430 from low side output terminal 418 to high side output terminal 416. This feature causes transistor 430 to typically operate in its conductive state when current flows through output port 414 from terminal 418 to 416, and little or no power is available at input port 408. In particular, current flowing through body diode 450 will generate a voltage V_diode, of around 0.7 volts, across diode 450. If Vth is less than V_diode, transistor 430 will typically conduct current in place of body diode 450. As discussed above, use of transistor 430, instead of its body diode 450, as a bypass device promotes efficiency because transistor 430 typically has a smaller voltage drop than body diode 450. Additionally, any power that might be available on input port 408 will drive transistor 430's gate positive with respect to its source via resistive device 452, thereby causing transistor 430 to operate further into its conductive state and further promote efficiency.

Some embodiments of controller 402 have one or more operating modes in addition to the MPPT and low power bypass operating modes. For example, certain embodiments further include a higher power bypass mode, where control subsystem 438, regulator 442, and low driver circuitry 446 are active, and control subsystem 438 causes freewheeling transistor 430 to continuously operate in its conductive state and control transistor 428 to continuously operate in its non-conductive state. The higher power bypass mode is used, for example, when photovoltaic device 404 provides enough power for control subsystem 438, regulator 442, and low side driver circuitry 446 to function, but not enough power to sustain MPPT operation.

Additionally, some embodiments of controller 402 are adapted to alternate between the MPPT and higher power bypass operating modes, when there is sufficient power available at input port 408 to power control subsystem 438, regulator 442, and low driver circuitry 446, but insufficient power available at input port 408 to sustain MPPT operation. In these embodiments, control subsystem 438 causes controller 402 to start in its MPPT mode and sustain MPPT operation until magnitude of input port voltage Vin drops below an under-voltage threshold value, corresponding to a collapse in photovoltaic device 404 voltage. Control subsystem 438 then causes controller 402 to switch to its higher power bypass mode, thereby allowing photovoltaic device 404 to recover such that its voltage rises. Once input port voltage Vin rises above a starting threshold value, control subsystem 438 causes controller 402 to switch to its MPPT mode, and the process repeats. Thus, in these embodiments, some power is extracted from photovoltaic device 404 even when device 404 is not producing enough power to support sustained MPPT operation. In certain of these embodiments, the starting threshold value is greater than the under-voltage threshold value to achieve hysteresis and thereby prevent oscillation between the two operating modes.

Although input capacitors 424, output capacitors 434, and energy storage inductance 436 are shown as being external to MPPT controllers 402, one or more of these components could be integrated within controllers 402 without departing from the scope hereof. Additionally, some or all of each MPPT controller 402 is implemented in a respective integrated circuit in certain embodiments, such as to promote small size, small parasitic impedance between components, and fast signal transfer time. In these embodiments, each integrated circuit is optionally co-packaged with its respective photovoltaic device 404 to promote small system size and minimal impedance between device 404 and controller 402. Additionally, in certain embodiments, a number of MPPT controllers 402 and photovoltaic devices 404 are co-packaged. However, MPPT controllers 402 are not limited to an integrated circuit implementation and could instead be formed partially or completely from discrete components.

MPPT controllers 402 are described above as potentially including a number of features, such as (a) high side transistor driver circuitry 444 powered from an adjacent controller's Vcc power rail, (b) resistive device 452 and voltage limiting subsystem 454 to support the low power bypass mode, (c) freewheeling transistor 430 having a lower threshold voltage than a forward voltage drop across body diode 450, and (d) being adapted to alternate between the MPPT and higher power bypass operating modes. It should be appreciated, however, that controllers 402 need not include all of these features, and some embodiments will include only one, two, or three of these features. For example, in some alternate embodiments, resistive device 452 and voltage limiting subsystem 454 are omitted such that MPPT controller 402 does not support the low power bypass mode. As another example, in some other alternate embodiments, resistive device 452 and voltage limiting subsystem 454 are present to support the low power bypass mode, but high side transistor driver circuitry 444 is powered from a bootstrap power supply instead of from the Vcc rail of an adjacent MPPT controller 402.

FIG. 6 shows an electric power system 600 including a string of N MPPT converters 402, where N is an integer greater than one. System 600 is similar to system 400 of FIG. 4, but with a different output circuit configuration. The controller output ports 414 are electrically coupled in series with a string optimizer 602, which is a power converter which electrically interfaces the string with a high power bus 604. String optimizer 602 converters a voltage across the string to a voltage on the high power bus, thereby allowing the string to be connected to the bus. Additionally, string optimizer 602 provides an electric power source for high side driver circuitry 444 of top MPPT controller 402(1). System 600 further includes a load 606 and one or more output capacitors 634 electrically coupled in parallel with load 606. Controllers 402 share energy storage inductance 636, which is distributed interconnection inductance of the output circuit connecting output ports 414, string optimizer 602, high power bus 604, and load 606. MPPT controllers 402 of FIG. 6 operate in a similar manner to that described above with respect to FIGS. 4 and 5.

Some alternate embodiments include features to improve fault tolerance. For example, some alternate embodiments of MPPT controller 402 include bootstrap power supply circuitry to power high side driver circuitry 444 in case the Vcc power supply rail of an adjacent controller is unavailable. An adjacent MPPT controller may be unable to provide Vcc power, for example, if its photovoltaic device is shaded or fails. As another example, in some other alternate embodiments, high side driver circuitry 444 is selectably powered from a Vcc power supply rail of two or more different MPPT controllers 402. Incorporation of backup bootstrap power supply circuitry or the ability to operate from two or more different Vcc power supply rails may prevent failure of one photovoltaic device or MPPT controller from affecting other elements of the string.

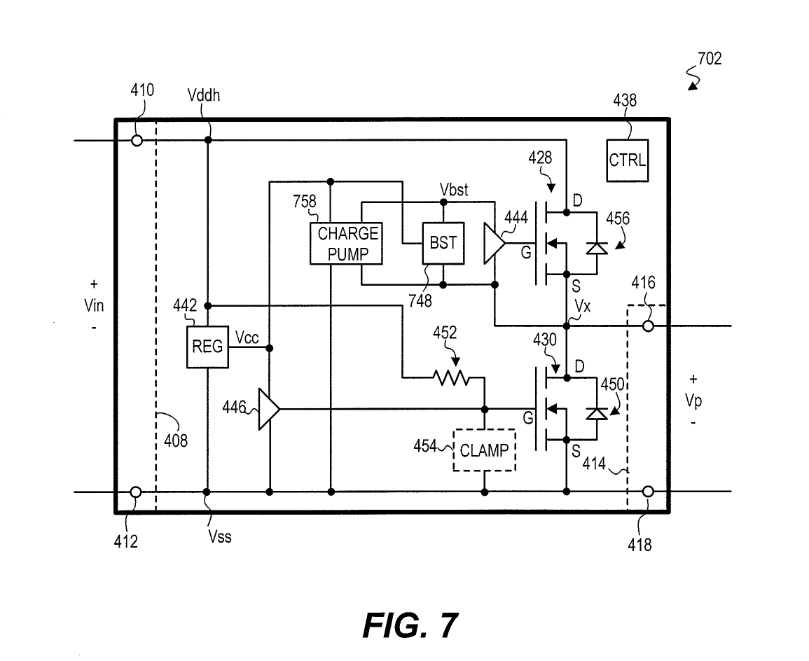

FIG. 7 shows an MPPT controller 702 which is similar to MPPT controller 402 of FIGS. 4 and 5, but includes a bootstrap power supply 748 and charge pump circuitry 758 to power high side transistor driver circuitry 444, in place of a connection to Vcc of an adjacent controller. Thus, MPPT controller 702 does not require daisy-chained Vcc connections between adjacent controller instances. Bootstrap power supply 748 generates a bootstrap power supply rail Vbst from Vcc, where Vbst is referenced to Vx. Bootstrap power supply rail Vbst powers high side transistor driver circuitry 444, allowing driver circuitry 444 to drive a gate-to-source voltage of control transistor 428 between at least two different levels to cause the transistor to switch between its conductive and non-conductive states, in response to a signal from control subsystem 438.

Bootstrap power supply 748 requires freewheeling transistor 430 to operate in its conductive state from time to time, so that a bootstrap capacitor (not shown) of power supply 748 may be recharged. Thus, bootstrap power supply 748 will not, in itself, support one hundred percent duty cycle operation of control transistor 428. However, charge pump circuitry 758 powers rail Vbst when bootstrap power supply 748 is unable to do so, such as when freewheeling transistor 430 operates in its non-conductive state for an extended period. In particular, charge pump circuitry 758 includes a switch network and one or more capacitors (not shown), adapted to transfer power from the Vcc/Vss domain to the Vbst/Vx domain. Accordingly, charge pump circuitry 758 enables certain embodiments of MPPT controller 702 to support one hundred percent duty cycle operation of control transistor 428. Controller 702 is typically configured such that bootstrap power supply 748 powers Vbst when feasible, and charge pump circuitry 758 powers Vbst when the bootstrap power supply is unable to do so, since the bootstrap power supply is typically more efficient than the charge pump circuitry.

Controller 702 otherwise operates in a manner similar to that discussed above with respect to controller 402. Resistive device 452 and voltage limiting subsystem 454 can be omitted if low power bypass mode support is not required. Additionally, charge pump circuitry 758 could alternately be powered from other power supply rails of controller 702, such as the Vddh/Vss rails, without departing from the scope hereof.

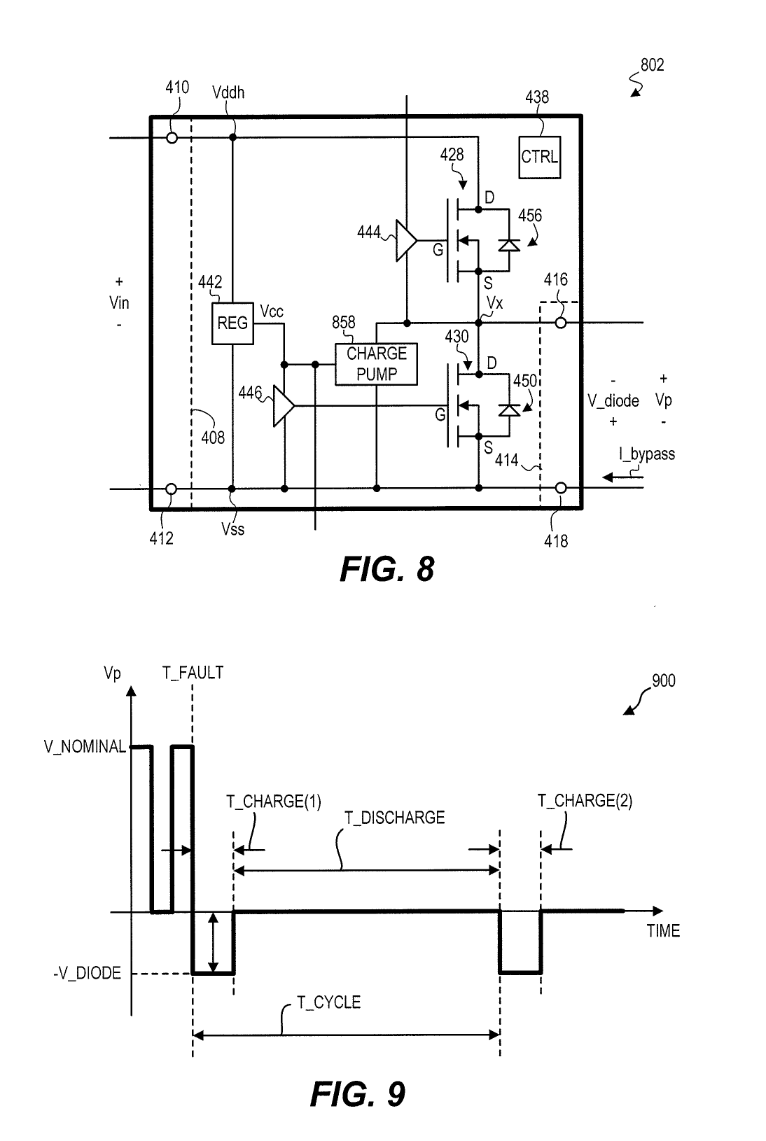

FIG. 8 shows an MPPT controller 802 which is similar to MPPT controller 402 of FIGS. 4 and 5, but includes charge pump circuitry 858 to enable controller 802 to operate freewheeling transistor 430 in its conductive state when power is unavailable at input port 408, but current is flowing through output port 414. Specifically, charge pump circuitry 858 receives power from output port 414 by up-converting a voltage drop across body diode 450 (V_diode) to a voltage that is high enough to at least partially power low side transistor driver circuitry 446 via the Vcc rail. Control subsystem 438 then causes low side transistor driver circuitry 446 to continuously operate freewheeling transistor 430 in its conductive state, such that bypass current I_bypass flows through transistor 430, instead of through its body diode 450. As discussed above, use of transistor 430, instead of its body diode 450, as a bypass device promotes efficiency because transistor 430 typically has a smaller voltage drop than body diode 450. Controller 438 is configured, for example, to operate freewheeling transistor 430 in its conductive state and control transistor 428 in its non-conductive state when V_diode exceeds a predetermined threshold value for a predetermined amount of time, indicating bypassing of a photovoltaic device (not shown) electrically coupled to input port 408.

In some embodiments, charge pump circuitry 858 is periodically charged from energy available from output port 414, and during such charging time, body diode 450, and not freewheeling transistor 430, is in its conductive state. Thus, body diode 450 and freewheeling transistor 430 alternately conduct current to provide a bypass path for bypass current I_bypass when power is unavailable at input port 408.

For example, FIG. 9 shows a graph 900 of output port voltage Vp versus time. Prior to time T_FAULT, a photovoltaic device electrically coupled to input port 408 is operating normally, and controller 802 generates a square wave output having a peak value of V_NOMINAL. At T_FAULT, the photovoltaic device stops providing power, such as due to shading. Low side transistor driving circuitry 446 is no longer powered, and body diode 450 conducts bypass current I_bypass, resulting in an output voltage equal to −V_DIODE. During period T_CHARGE(1), charge pump circuitry 858 is charged—that is, it stores energy from output port 414 while body diode 450 conducts. At the end of T_CHARGE(1), charge pump circuitry 858 enables control subsystem 438 and low side transistor driver circuitry 446 to operate freewheeling transistor 430 in its conductive state during a period T_DISCHARGE, such that output port voltage Vp is close to zero due to the freewheeling transistor's low forward voltage drop. At the expiration of period T_DISCHARGE, charge pump circuitry 858 is charged again during period T_CHARGE(2) while body diode 450 again conducts. Charge/discharge cycle T_CYCLE repeats until the photovoltaic device resumes providing power or bypass current I_bypass drops to zero. T_DISCHARGE is typically significantly greater than T_CHARGE, and freewheeling transistor 430 therefore typically conducts the majority of cycle T_CYCLE, promoting efficient bypassing. In particular, use of charge pump circuitry 858 to enable operation of freewheeling transistor 430 when the photovoltaic device is not providing power reduces losses by approximately T_CHARGE/T_CYCLE when bypassing bypass current I_bypass.

In certain alternate embodiments, the output of charge pump circuitry 858 is electrically coupled to the gate of freewheeling transistor 430, instead of to power supply rail Vcc. In these embodiments, charge pump circuitry 858 directly powers transistor 430's gate, such that charge pump circuitry 858 controls transistor 430 during bypass operation. Charge pump circuitry 858 controls transistor 430 during bypass operation in a manner similar to that discussed above with respect to FIGS. 8 and 9.

MPPT controller 802 optionally includes resistive device 452 and voltage limiting subsystem 454 to support a low power bypass mode, in a manner similar to that of MPPT controller 402 (FIGS. 4 and 5). Optional resistive device 452 and voltage limiting subsystem 454 are not shown in FIG. 8, however, to promote illustrative clarity. Additionally, in some alternate embodiments, MPPT controller 802 further includes bootstrap circuitry (not shown), or additional charge pump circuitry (not shown), for powering high side transistor driver circuitry 444.

Combinations of Features

Features described above as well as those claimed below may be combined in various ways without departing from the scope hereof. The following examples illustrate some possible combinations:

(A1) An electric power system may include a string of N maximum power point tracking (MPPT) controllers having output ports electrically coupled in series, where N is an integer greater than one. At least one of the N MPPT controllers may include respective transistor driver circuitry powered from a power supply rail of an adjacent one of the N MPPT controllers of the string.

(A2) In the electric power system denoted as (A1), one of the N MPPT controllers may include transistor driver circuitry powered from an electric power source separate from the string of N MPPT controllers.

(A3) In the electric power system denoted as (A2), the electric power source separate from the string of N MPPT controllers may be an electric power source of a power converter interfacing the string of N MPPT controllers with a power bus.

(A4) In any of the electric power systems denoted as (A1) through (A3), each of the N MPPT tracking controllers may include an input port electrically coupled to a respective photovoltaic device.

(B1) A maximum power point tracking (MPPT) controller may include (a) an input port for electrically coupling to an electric power source, the input port having low side and high side input terminals; (b) an output port for electrically coupling to a load, the output port having low side and high side output terminals; (c) a control transistor electrically coupled between the high side input terminal and the high side output terminal; (d) an n-channel field effect freewheeling transistor having a gate, a drain, and a source, the drain electrically coupled to the high side output terminal and the source electrically coupled to the low side output terminal; (e) transistor driver circuitry adapted to drive a gate-to-source voltage of the freewheeling transistor between at least two different voltage levels; and (f) a resistive element electrically coupled between the high side input terminal and the gate of the freewheeling transistor, where the low side input terminal is electrically coupled to the low side output terminal.

(B2) The MPPT controller denoted as (B1) may further include a voltage limiting subsystem electrically coupled between the gate and source of the freewheeling transistor, where the voltage limiting subsystem is adapted to limit a magnitude of the gate-to-source voltage of the freewheeling transistor to a maximum value.

(B3) In either of the MPPT controllers denoted as (B1) or (B2), the freewheeling transistor may include a body diode with an anode electrically coupled to the low side output terminal and a cathode electrically coupled to the high side output terminal, and a threshold voltage of the freewheeling transistor may be less than a forward conduction voltage of the body diode.

(B4) Any of the MPPT controllers denoted as (B1) through (B3) may further include a control subsystem adapted to cause the control transistor to repeatedly switch between its conductive and non-conductive states to maximize an amount of power extracted from an electric power source electrically coupled to the input port, in an MPPT operating mode of the MPPT controller.

(B5) In the MPPT controller denoted as (B4), the control subsystem may be further adapted to cause the freewheeling transistor to repeatedly switch between its conductive and non-conductive states in the MPPT operating mode of the MPPT controller to provide a path for current flowing through the output port when the control transistor is in its non-conductive state.

(B6) In either of the MPPT controllers denoted as (B4) or (B5) the control subsystem may be further adapted to cause the control transistor to continuously operate in a non-conductive state, and the freewheeling transistor to continuously operate in a conductive state, in a bypass operating mode of the MPPT controller.

(B7) In the MPPT controller denoted as (B6), the control subsystem may be further adapted to cause the MPPT controller to alternate between its MPPT and bypass operating modes when power available at the input port is sufficient to power the control subsystem but insufficient to sustain MPPT operation.

(B8) In any of the MPPT controllers denoted as (B1) through (B7): (a) the control transistor may be an n-channel field effect transistor having a gate, a drain, and a source, the drain electrically coupled to the high side input terminal and the source electrically coupled to the high side output terminal; and (b) the MPPT controller may further include: (1) high side transistor driver circuitry adapted to drive a gate-to-source voltage of the control transistor between at least two different voltage levels, (2) a bootstrap power supply adapted to power the high side transistor driver circuitry from a power supply rail of the MPPT controller, and (3) charge pump circuitry adapted to power the high side transistor driver circuitry from the power supply rail of the MPPT controller when the bootstrap power supply is unable to power the high side transistor driver circuitry.

(C1) A maximum power point tracking (MPPT) controller may include: (a) an input port for electrically coupling to an electric power source; (b) an output port for electrically coupling to a load; (c) n-channel field effect freewheeling transistor electrically coupled across the output port; (d) a control subsystem adapted to control a gate-to-source voltage of the freewheeling transistor; and (e) a resistive device electrically coupled between the input port and the gate of the freewheeling transistor such that the freewheeling transistor operates in its conductive state when power is applied to the input port and the control subsystem is in an inactive state.

(C2) The MPPT controller denoted as (C1) may further include a control transistor electrically coupled between the input port and the output port, and the control subsystem may be further adapted to cause the control transistor to repeatedly switch between its conductive and non-conductive states to maximize power extracted from an electric power source electrically coupled to the input port, in an MPPT operating mode of the MPPT controller.

(C3) In either of the MPPT controllers denoted as (C1) or (C2), the freewheeling transistor may include a body diode, and a threshold voltage of the freewheeling transistor may be less than a forward conduction voltage of the body diode.

Changes may be made in the above methods and systems without departing from the scope hereof. For example, the number of MPPT controllers in a string could be varied. It should thus be noted that the matter contained in the above description and shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

What is claimed is:

1. An electric power system, comprising a string of N maximum power point tracking (MPPT) controllers having output ports electrically coupled in series, N being an integer greater than one, at least one of the N MPPT controllers including respective transistor driver circuitry powered from a power supply rail of an adjacent one of the N MPPT controllers of the string.

2. The electric power system of claim 1, one of the N MPPT controllers including transistor driver circuitry powered from an electric power source separate from the string of N MPPT controllers.

3. The electric power system of claim 2, the electric power source separate from the string of N MPPT controllers being an electric power source of a power converter interfacing the string of N MPPT controllers with a power bus.

4. The electric power system of claim 2, each of the N MPPT tracking controllers including an input port electrically coupled to a respective photovoltaic device.

5. An electric power system, comprising:
first and second photovoltaic devices;
a first maximum power point tracking (MPPT) controller including an input port electrically coupled to the first photovoltaic device; and
a second MPPT controller including an input port electrically coupled to the second photovoltaic device;
output ports of the first and second MPPT controllers being electrically coupled in series, and
transistor driver circuitry of the second MPPT controller being powered from a power supply rail of the first MPPT controller.

6. The electric power system of claim 5, further comprising:
third and fourth photovoltaic devices;
a third MPPT controller including an input port electrically coupled to the third photovoltaic device; and
a fourth MPPT controller including an input port electrically coupled to the fourth photovoltaic device,
output ports of the first, second, third, and fourth MPPT controllers being electrically coupled in series,
transistor driver circuitry of the third MPPT controller being powered from a power supply rail of the second MPPT controller, and
transistor driver circuitry of the fourth MPPT controller being powered from a power supply rail of the third MPPT controller.

7. The electric power system of claim 6, transistor driver circuitry of the first MPPT controller being powered from an electric power source separate from the first, second, and third MPPT controllers.

8. The electric power system of claim 7, the electric power source separate from the first, second, and third MPPT controllers being an electric power source of a power converter interfacing the MPPT controllers with a power bus.

9. The electric power system of claim 5, further comprising:
a third photovoltaic device; and
a third MPPT controller including an input port electrically coupled to the third photovoltaic device,
output ports of the first, second, and third MPPT controllers being electrically coupled in series,
transistor driver circuitry of the third MPPT controller being selectably powered from either a power supply rail of the second MPPT controller or the power supply rail of the first MPPT controller.

10. An electric power system, comprising:
first and second photovoltaic devices;
a first maximum power point tracking (MPPT) controller, including:
a first input port electrically coupled to the first photovoltaic device,
a first output port including a first high side output terminal and a first low side output terminal,
a first power supply rail referenced to the first low side output terminal,
a first transistor referenced to the first high side output terminal, and
first transistor driver circuitry adapted to drive a gate-to-source voltage of the first transistor between at least two different voltage levels; and
a second MPPT controller, including:
a second input port electrically coupled to the second photovoltaic device,
a second output port including a second high side output terminal and a second low side output terminal, the second high side output terminal being electrically coupled to the first low side output terminal,
a second transistor referenced to the second high side output terminal, and
second transistor driver circuitry powered from the first power supply rail, the second transistor driver circuitry adapted to drive a gate-to-source voltage of the second transistor between at least two different voltage levels.

11. The electric power system of claim 10, wherein the second MPPT controller further includes a second power supply rail referenced to the second low side output terminal, and wherein the electric power system further comprises:
a third photovoltaic device; and
a third MPPT controller, including:
a third input port electrically coupled to the third photovoltaic device,
a third output port including a third high side output terminal and a third low side output terminal, the third high side output terminal being electrically coupled to the second low side output terminal,
a third transistor referenced to the third high side output terminal, and
third transistor driver circuitry powered from the second power supply rail, the third transistor driver circuitry adapted to drive a gate-to-source voltage of the third transistor between at least two different voltage levels.

12. The electric power system of claim 11, the first transistor driver circuitry being powered from an electric power source separate from the first, second, and third MPPT controllers.

13. The electric power system of claim 12, the electric power source separate from the first, second, and third MPPT controllers being an electric power source of a power converter interfacing the MPPT controllers with a power bus.

14. The electric power system of claim 12, each of the first, second, and third transistors being an N-channel field effect transistor.

15. A maximum power point tracking (MPPT) controller, comprising:
an input port for electrically coupling to an electric power source, the input port having low side and high side input terminals;
an output port for electrically coupling to a load, the output port having low side and high side output terminals;
a control transistor electrically coupled between the high side input terminal and the high side output terminal;
an n-channel field effect freewheeling transistor having a gate, a drain, and a source, the drain electrically coupled to the high side output terminal and the source electrically coupled to the low side output terminal;
transistor driver circuitry adapted to drive a gate-to-source voltage of the freewheeling transistor between at least two different voltage levels; and
a resistive element electrically coupled between the high side input terminal and the gate of the freewheeling transistor,
the low side input terminal being electrically coupled to the low side output terminal.

16. The MPPT controller of claim 15, further comprising a voltage limiting subsystem electrically coupled between the gate and source of the freewheeling transistor, the voltage limiting subsystem adapted to limit a magnitude of the gate-to-source voltage of the freewheeling transistor to a maximum value.

17. The MPPT controller of claim 15, the freewheeling transistor including a body diode with an anode electrically coupled to the low side output terminal and a cathode electrically coupled to the high side output terminal, a threshold voltage of the freewheeling transistor being less than a forward conduction voltage of the body diode.

18. The MPPT controller of claim 15, further comprising a control subsystem adapted to cause the control transistor to repeatedly switch between its conductive and non-conductive states to maximize an amount of power extracted from an electric power source electrically coupled to the input port, in an MPPT operating mode of the MPPT controller.

19. The MPPT controller of claim 18, the control subsystem further adapted to cause the freewheeling transistor to repeatedly switch between its conductive and non-conductive states in the MPPT operating mode of the MPPT controller to provide a path for current flowing through the output port when the control transistor is in its non-conductive state.

20. The MPPT controller of claim 18, the control subsystem further adapted to cause the control transistor to continuously operate in a non-conductive state, and the freewheeling transistor to continuously operate in a conductive state, in a bypass operating mode of the MPPT controller.

21. The MPPT controller of claim 20, the control subsystem further adapted to cause the MPPT controller to alternate between its MPPT and bypass operating modes when power available at the input port is sufficient to power the control subsystem but insufficient to sustain MPPT operation.

22. The MPPT controller of claim 18, wherein:
the control transistor is an n-channel field effect transistor having a gate, a drain, and a source, the drain electrically coupled to the high side input terminal and the source electrically coupled to the high side output terminal; and
the MPPT controller further comprises:
high side transistor driver circuitry adapted to drive a gate-to-source voltage of the control transistor between at least two different voltage levels,
a bootstrap power supply adapted to power the high side transistor driver circuitry from a power supply rail of the MPPT controller, and
charge pump circuitry adapted to power the high side transistor driver circuitry from the power supply rail of the MPPT controller when the bootstrap power supply is unable to power the high side transistor driver circuitry.

23. A maximum power point tracking (MPPT) controller, comprising:
an input port for electrically coupling to an electric power source;
an output port for electrically coupling to a load;
n-channel field effect freewheeling transistor electrically coupled across the output port;
a control subsystem adapted to control a gate-to-source voltage of the freewheeling transistor; and
a resistive device electrically coupled between the input port and the gate of the freewheeling transistor such that the freewheeling transistor operates in its conductive state when power is applied to the input port and the control subsystem is in an inactive state.

24. The MPPT controller of claim 23, further comprising a control transistor electrically coupled between the input port and the output port, the control subsystem further adapted to cause the control transistor to repeatedly switch between its conductive and non-conductive states to maximize power extracted from an electric power source electrically coupled to the input port, in an MPPT operating mode of the MPPT controller.

25. The MPPT controller of claim 23, the freewheeling transistor including a body diode, a threshold voltage of the freewheeling transistor being less than a forward conduction voltage of the body diode.

26. A method for operating a maximum power point tracking (MPPT) controller including an input port electrically coupled to a photovoltaic device and an output port electrically coupled to a load, comprising the steps of:
operating the MPPT controller in an MPPT operating mode, where the MPPT controller maximizes power extracted from the photovoltaic device and transferred to the load;
switching the MPPT controller from the MPPT operating mode to a bypass operating mode when a voltage across the input port drops below an under-voltage threshold value, the MPPT controller causing a transistor electrically coupled across the output port to continuously operate in a conductive state while in the bypass operating mode; and
switching the MPPT controller from the bypass operating mode to the MPPT operating mode when the voltage across the input port rises above a starting threshold value.

27. The method of claim 26, the starting threshold value being greater than the under-voltage threshold value.
